(19) United States
(12) Patent Application Publication
(10) Pub. No.: US 2001/0055750 A1
(43) Pub. Date: Dec. 27, 2001

(54) Method and apparatus for educating asthma sufferers and caregivers

(76) Inventors: Jeanette D. Rasche, Evans, GA (US); Warren Whitlock, Evans, GA (US)

Correspondence Address: Office of the Staff Judge Advocate, U.S. Army Medical Research and Material Command, ATT: MCMR-JA (Ms. Elizabeth Arwine), 504 Scott Street, Fort Detrick, MD, 21702-5012, US

(21) Appl. No.: 09/829,007

(22) Filed: Apr. 10, 2001

Related U.S. Application Data
(60) Provisional application No. 60/195,329, filed on Apr. 10, 2000.

(51) Int. Cl. G09B 7/00

(52) U.S. Cl. 434/322

(57) ABSTRACT

A method and system preferably is for use in treating asthma patients by applying a score to the severity of the asthma based on answers to a series of questions. The system further preferably includes interactive education including what is asthma, how to lessen the likelihood of asthma attacks, and how to treat an asthma attack.

This application claims the benefit of U.S. provisional Application Ser. No. 60/195,329, filed Apr. 10, 2000, which is hereby incorporated by reference.

I. Field of the Invention

The invention is directed at an assessment method and apparatus for asthma patients and healthcare providers to use in assessing a particular case of asthma and/or learning about different aspects of asthma. More particularly, the invention relates to a scoring system for determining the severity of asthma and the current situation of an asthma patient.

II. Background of the Invention

Over 100 million people worldwide have asthma. Uncontrolled asthma can lead to emergency room visits, hospitalizations and reduced quality of life. There are clinical practice guidelines for asthma that define the “right things to do” in delivering consistent and standardized asthma care. These guidelines have been developed by a panel of medical experts, and distributed to medical facilities and individual health care providers in the form of extensive documentation. Often times, the valuable information contained within the asthma clinical practice guidelines is not utilized because it is not readily accessible to the health care providers or patient when it is needed. In most cases, these guidelines are placed on a shelf or in a file cabinet, and remain largely unaddressed or unreferenced, if not entirely forgotten. The inaccessibility or inconvenience of the material contained within the asthma clinical practice guidelines results in asthma patients receiving variable care that may lead to uncontrolled asthma.

The problem of how to score an individual patient's asthma severity has not been clear. Asthma specialists often use expensive pulmonary function testing to assess severity, some providers, use peak flow meter readings, or other “questionnaires,” and most do not use a specific tool at all.

The National Institute of Health (NIH) and the National Heart Lung Blood Institute (NHLBI) developed and distributed clinical practice guidelines for asthma through traditional printing and web-posted documentation. Under the most recent (1997) NIH/NHLBI asthma clinical practice guidelines, there are four categories of severity: mild intermittent, mild persistent, moderate persistent and sever persistent asthma. According to the guidelines, a health care provider must determine an asthmatic's severity category prior to implementing or modifying a treatment regimen. NIH/NHLBI has termed this the “step-wise” approach to asthma care. The best way to determine the severity is based on the frequency of symptoms, which are covered within the generic questions. These guidelines do not provide a uniform way to score a set of answers to the questions to determine the appropriate asthma severity level.

What is lacking in the NIH/NHLBI and all other asthma clinical practice guidelines is a tool that allows the health care provider to make an easy determination of asthma severity in a particular patient. Health care providers who attempt to adhere to the NIH/NHLBI clinical practice guidelines for asthma often utilize an inappropriate level of therapy, because no tool is available for asthma severity assessment. Inappropriate therapy may lead to uncontrolled asthma symptoms. Uncontrolled asthma can lead to high cost medical care, including emergency room and inpatient hospital visits.

Asthma has been identified by the Surgeon General as being a “top 20” priority for clinical pathway implementation and targeted by Health Affairs for widespread educational programs. Over 50 percent of the cost for asthma care is directly due to emergency visits and hospitalizations. Patients seek emergency care and are hospitalized only when their asthma is uncontrolled. Failure to monitor and recognize the symptoms of an asthma attack and begin effective therapy in a preventative fashion is directly responsible for asthma that becomes uncontrolled. The Pharmaco-Economic Study in 1995 showed the need for effective education of patients and healthcare providers in prevention, monitoring, and managing of asthma.

Notwithstanding the usefulness of the above-described approaches, a need still exists for a way to improve the care given to asthma patients.

III. Summary of the Invention

The invention in its basic form is an expert system based software to numerically score and report one of four severity classes of asthma based on the answers to a series of questions. The expert system preferably is provided in two different software packages, one aimed at patients and the other aimed at healthcare providers. Both software packages provide a uniform education message to all individuals regarding asthma.

The invention in its broader aspects preferably is a system for scoring an asthma severity for a patient based on information entered by a user regarding the patient including: means for questioning the user regarding the patient, means for accumulating a score for at least one indicator based on answers entered by the user to the questions, means for correlating the accumulated score to at least one indicator level, and means for informing the user of the at least one indicator level from said correlating means.

The invention in its broader aspects preferably is a method for assessing asthma patients comprising: repeating the following for each question of an assessment, asking a question, receiving an answer to the question, and incrementing a score for at least one indicator based on the answer to the question; correlating each of the at least one indicator score to a corresponding at least one indicator level; and providing the at least one indicator level.

The invention in its broader aspects preferably is a method for assessing severity of asthma for a patient comprising: a) transmitting a question to an individual, b) receiving an answer to the transmitted question from the individual, c) accumulating a score for at least one indicator based upon the received answer, d) repeating steps a through c for each question in a series of questions, and e) transmitting at least one indicator level based on the at least one indicator score to the individual.

The invention in its broader aspects preferably is an apparatus for assessing a patient's asthma comprising: an interface, a first database in communication with said interface, said first database includes questions relating to asthma, a calculator in communication with said interface, and an assessor in communication with said calculator and said interface. An alternative embodiment of the invention preferably includes a processor, a memory connected to said processor, a display connected to said processor, and an input device connected to said processor; and wherein said interface interacts with said processor such that said processor instructs said display to show said interface on said display and said input device provides an user's input based upon said interface being shown on said display, said first database resides in said memory, and said calculator and said assessor reside in said processor.

An objective of the invention is to assess a patient's symptoms to determine the severity of their asthma.

A further objective of the invention is to improve asthma treatment and thus lower health costs associated with asthma.

A further objective of the invention is to educate patients and healthcare providers about asthma including, for example, what triggers asthma and the proper way to take medications.

Another objective of the invention is to provide easily accessible documents and forms regarding asthma such as a school form for students to take to school describing their medications, asthma control plans, and a booklet on how to control asthma and how to take medications.

Another objective of the invention is to provide information discussing asthma with respect to pregnant women, minority children, and the elderly.

Yet another objective of the invention is to increase the retention rates of asthma information by patients and/or healthcare providers.

An advantage of the invention is a scoring system that provides a level of asthma severity to allow for improved and more accurate treatment of asthma patients. Furthermore, the assessment may be repeated during each visit by the patient to the doctor to provide an indication as to the effectiveness of the chosen therapy in combating the patient's asthma. This is especially true given that the goal of therapy is to reduce the frequency of symptoms for the patient.

Another advantage of the invention is the ease in which users are able to navigate the system to obtain desired information and obtain an assessment regarding the severity of an asthma case.

Another advantage of the invention is that it delivers “just-in-time” education to both patients and healthcare providers.

Another advantage of the invention is the generation of uniform forms for all users.

A further advantage of the invention is the opportunity for healthcare providers to obtain continuing education credits by completing case studies.

The inventors have developed a new interactive, multimedia education program, which has provided information retention rates of over 90% in experimental trials. The unique properties of this interactive program include an animated illustration that shows bronchospasm and inflammation. A self-assessment tool is included that actually diagnoses a patient's severity of asthma.

Based on the severity of that patient's asthma, the proper medications and asthma control plan can be developed. It is one of the most novel developments in disease management to attain comprehensive asthma education through interactive multimedia software.

Given the following enabling description of the drawings, the method should become evident to a person of ordinary skill in the art.

### BRIEF DESCRIPTION OF THE DRAWINGS

FIG. 1 illustrates a block diagram representation of the invention.

FIGS. 2(a)-(c) depict the invention as flowcharts representing method steps for different aspects of the invention.

FIG. 3 illustrates the patient script of the preferred embodiment of the invention.

FIG. 4 depicts the provider script of the preferred embodiment of the invention.

FIG. 5 illustrates the scoring system of the preferred embodiment of the invention for determining asthma severity for a patient.

FIG. 6 depicts the scoring system of the preferred embodiment of the invention for determining performance limitations.

FIG. 7 illustrates the scoring system of the preferred embodiment of the invention for determining the level of rescue medication taken by the patient and monitoring performed by the patient.

FIG. 8 depicts the scoring system of the preferred embodiment of the invention for determining the quality of life of the patient.

FIG. 9 illustrates an exemplary asthma self-assessment survey result that may be used in conjunction with the preferred embodiment of the invention when the user is the patient.

FIG. 10 depicts an exemplary asthma self-assessment survey result that may be used in conjunction with the preferred embodiment of the invention when the user is the healthcare provider.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. The present invention will now be described more fully hereinafter with reference to the accompanying drawings, in which preferred embodiments of the invention are shown. Like numbers refer to like elements throughout.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code means embodied in the medium. Any suitable computer readable medium may be utilized including hard disks, CD-ROMs, optical storage devices, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. More preferably, the present invention is created using Macromedia Authorware or Macromedia Flash.

The program code may execute entirely on the user's computer, as a stand-alone software package; on a remote computer; or it may execute partly on the user's computer and partly on a remote computer. In the latter scenario, the remote computer may be connected directly to the user's computer through a LAN or a WAN (Intranet), or the connection may be made indirectly through an external computer (for example, through the Internet using an Internet Service Provider). The invention preferably is implemented as software that may be resident on a stand-alone device such as a personal computer, a PAL device, a personal digital assistant (PDA), an e-book or other handheld or wearable computing devices (incorporating Palm OS, Windows CE, EPOC, or future generations like code-named products Razor from 3Com or Bluetooth from a consortium including IBM and Intel), or a specific purpose device having an application specific integrated circuit (ASIC).

The present invention is described below with reference to flowchart illustrations of methods, apparatus (systems) and computer program products according to an embodiment of the invention. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. Examples of how the software can be stored for use are the following: in random access memory (RAM); in read only memory (ROM); on a storage device like a hard drive, disk, compact disc, punch card, tape or other computer readable material; in virtual memory on a network, a computer, an intranet, the Internet, the Abilene Project, or otherwise; on an optical storage device; on a magnetic storage device; and/or on an EPROM.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

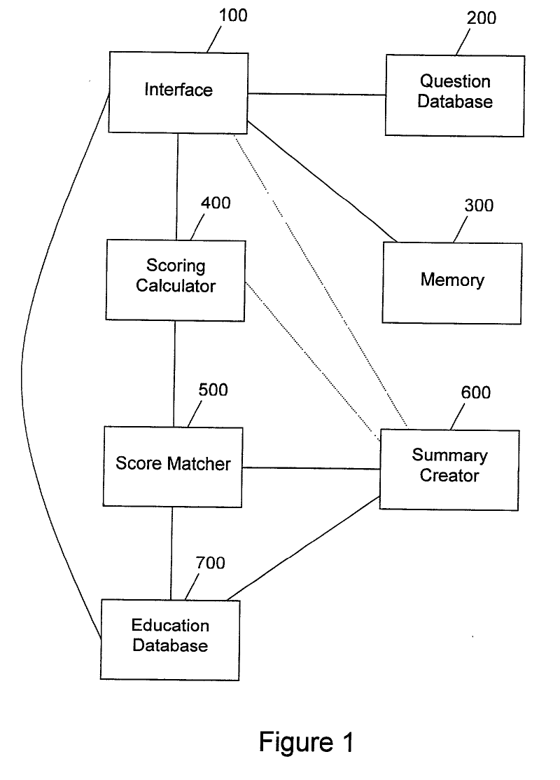

FIGS. 1-8 illustrate the preferred embodiment of the invention. In general, the present invention defines an asthma assessment and education system and method. More preferably, the invention is multimedia software allowing for interaction between the user, which may be either an asthma patient or a healthcare provider (practitioner), and the software. Even more preferably, the software presentations are programmed using Macromedia Authorware software, which allows for the inclusion of digital video (AVI format) and audio files (WAV and SWA formats) along with having embedded digital images and text in the produced multimedia presentation.

FIG. 1 illustrates the preferred block diagram structure for the system. The system preferably includes an interface 100, a question database 200, a memory for storing received information 300, a scoring calculator (accumulator) 400, a score matcher (a correlating component) 500, and a summary creator 600.

The interface 100 preferably provides the way for information to be exchanged between the system and the user, who may be a patient or a practitioner. The interface 100 preferably will display questions from the question database 200 for the user to answer along with receiving those answers. Preferably, the interface 100 will display the questions in a random order to decrease the likelihood of the user from falling into a pattern when repeating the assessment over a number of times. The interface 100 preferably is a graphical interface that will be displayed on, for example, a computer monitor or other type of display device for the user to view and interact with by answering questions as prompted using a variety of input devices such as a keyboard, a touch screen, a mouse, or a microphone for receiving voice communication. The interface 100 preferably would then receive the signal from the particular input device particularly when the system is implemented as software.

The interface 100 preferably provides the answers to the memory 300 and/or the scoring calculator 400 depending upon the implementation desired. The scoring calculator 400 preferably tracks scores for different indicators such as the severity of the asthma, patient compliance, and/or limitations experienced by the patient due to asthma. After the questions are asked of the user, preferably the scoring calculator 300 will supply the score matcher 500 with the tallied scores. The score matcher 500 preferably then rates the received score(s) based on predetermined criteria to provide level(s) for the respective indicator(s). The predetermined criteria may be resident within the score matcher 500, the question database 200, or some other form of memory/storage (not illustrated).

The summary creator 600 preferably receives the indicator level(s) received from the score matcher 500. The summary creator 600 may also receive the answers from either the memory 300 or the interface 100. The summary creator 600 preferably provides a summary of the collected information through the interface 100 to the user based on the assessment.

A further embodiment preferably includes an education database 700. Preferably, the education database 700 will interact with the interface 100 such that the interface 100 receives presentation data from the education database 700. The presentation data preferably may include written materials, multimedia presentations including interactive segments, and/or information about asthma. A further alternative embodiment is that the education database 700 will include elements that can be adapted to the user based upon the assessment results and thus will preferably also be in communication with at least one of the score matcher 500 and the summary creator 600.

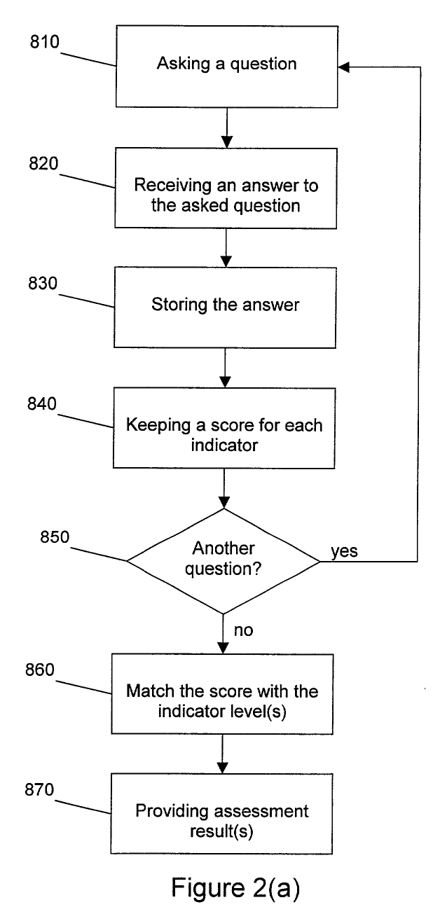

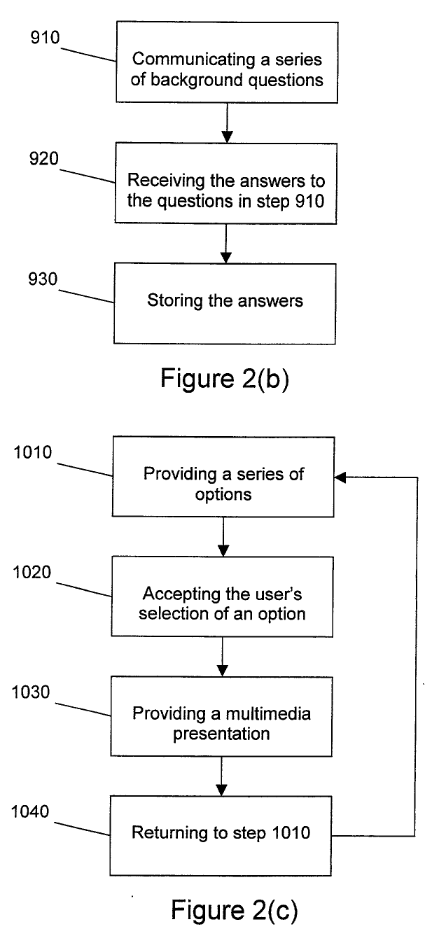

FIG. 2(a) provides another representation of the invention as a flowchart showing the steps to perform the preferred method of the invention. Step 810 preferably is asking the user a question from a series of questions as part of the asthma assessment. Step 810 may include asking the series of questions in a random order. Step 820 preferably is receiving an answer to the question asked in step 810. Step 830 preferably is temporarily storing the series of answers, although this step may be omitted or may involve storing the answers for use at a later time. Step 840 preferably includes keeping a score/tally for each indicator being assessed based on predetermined scoring breakdowns as will be discussed by way of example latter in this description. Step 850 preferably is to repeat step 810 through step 840 for each question in the assessment. Step 860 preferably then matches the score(s) maintained in step 840 with the relevant indicator level(s).

Step 870 preferably is to provide the resulting indicator to the user or another person. More preferably, step 870 includes providing an assessment summary that includes information that is of use for the patient and/or medical professional. In addition or alternatively, step 870 may also include storing the resulting indicator(s) associated with a particular patient identifier. If step 870 stores the information, then the stored information will be able to be later retrieved by the user, patient, and/or another for, for example, review and/or analysis. The stored information may include any information about the assessment that might be useful to have at a later time including, for example, answers to questions and date/time of the assessment.

Additional steps that may be included as part of the method if desired are as follows and are shown in FIG. 2(b). Step 910 preferably is communicating a series of background questions to the user regarding the asthma patient such as name, identification number (e.g., social security number), contact information, medical doctor, location, etc. Step 920 preferably is receiving the answers from the user to the series of background questions. Step 930 preferably includes storing the answers for later use either as part of this method and/or latter access for further evaluation/study. These steps may occur at the beginning of the preferred method, which would allow for a personalization of the assessment questions asked of the user, during the method as part of the randomization of the questions, or at the end of the assessment.

An alternative embodiment of the method is to include an educational portion, which is illustrated in FIG. 2(c). The educational portion preferably will include a series of steps to educate the user about asthma. Step 1010 preferably is providing a series of options for the user to choose between, more preferably the options will represent different aspects of asthma. Step 1020 preferably is accepting the user's selection. Step 1030 preferably then provides the multimedia presentation or other type of educational information associated with the user's selection. Step 1030 may include providing a voice over that accompanies the visual presentation aspect of the multimedia presentation. Alternatively, step 1030 may also include providing the user with documentation relating to the selected option, and more preferably the documentation will be provided such that the user can either print it or store it on a computer readable medium that the user can access at a later time. Step 1040 preferably is to return the user to step 1010.

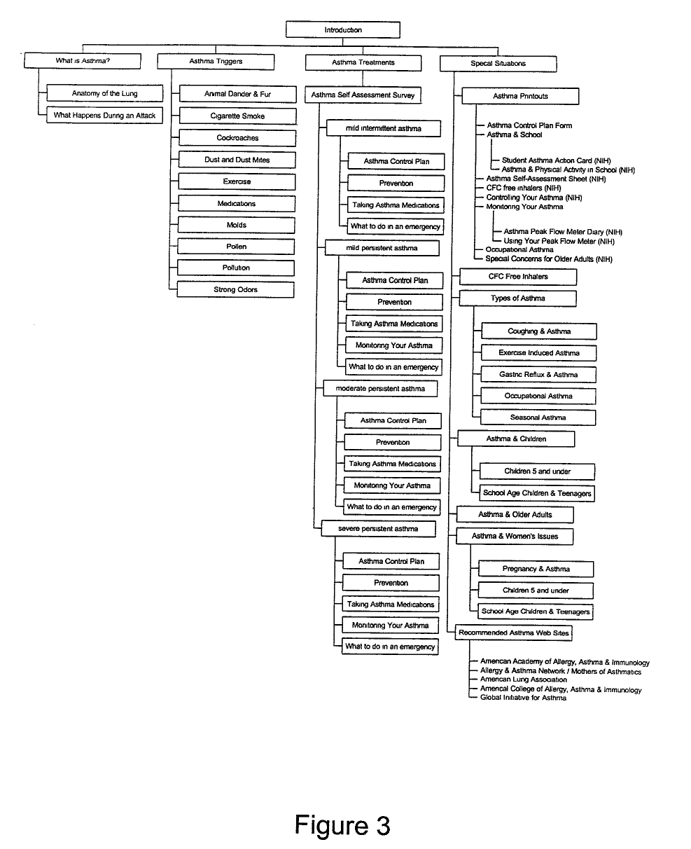

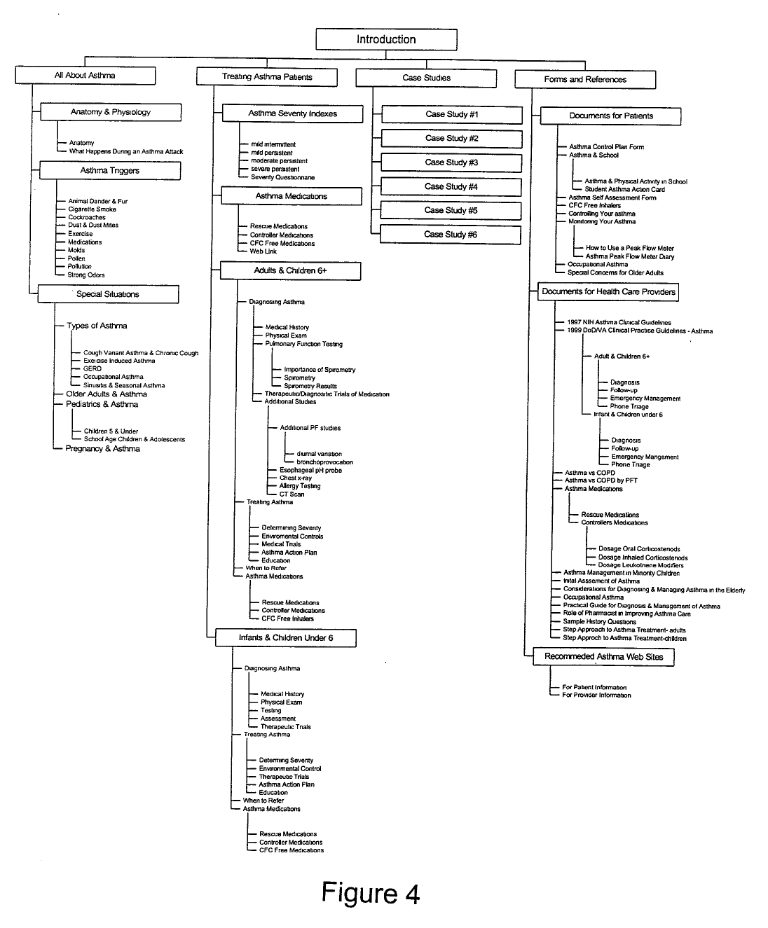

As such the software preferably is a menu-driven system allowing the user to select particular areas such as those illustrated in FIGS. 3 and 4, which are offered as examples of topics that may be included within this system, after going through the introduction and/or assessment. Most preferably, the software will include a series of submenu driven routines with each having further menus providing further choices and selections. An example of this is that the “Introduction” in both FIGS. 3 and 4 leads to a menu that allows selection of one of four menu choices in addition to an “exit” selection. The patient and healthcare provider scripts may be combined into one software package or may be placed in separate software packages.

The preferred embodiment of the invention allows the user to proceed through each of the information presentations at their own respective pace, for example, by using forward and backward buttons to proceed through each presentation. This type of arrangement allows the user the opportunity to observe and learn each piece of the presentation, which will increase the likelihood that the user will retain the information.

Both the patient and healthcare provider scripts preferably incorporate an asthma assessment that under the patient script has the patient enter the relevant information while under the provider script the healthcare provider enters the relevant information. Preferably, the questions asked in the assessment are asked in a randomized order to prevent pattern recognition by the user. By randomizing the questions, the assessment may be utilized during each visit to the doctor by the patient or even at regular intervals by the patient at home, who would then forward the results to the doctor or other healthcare provider. Alternatively, the patient may take the assessment over a network by running the software on a remote computer.

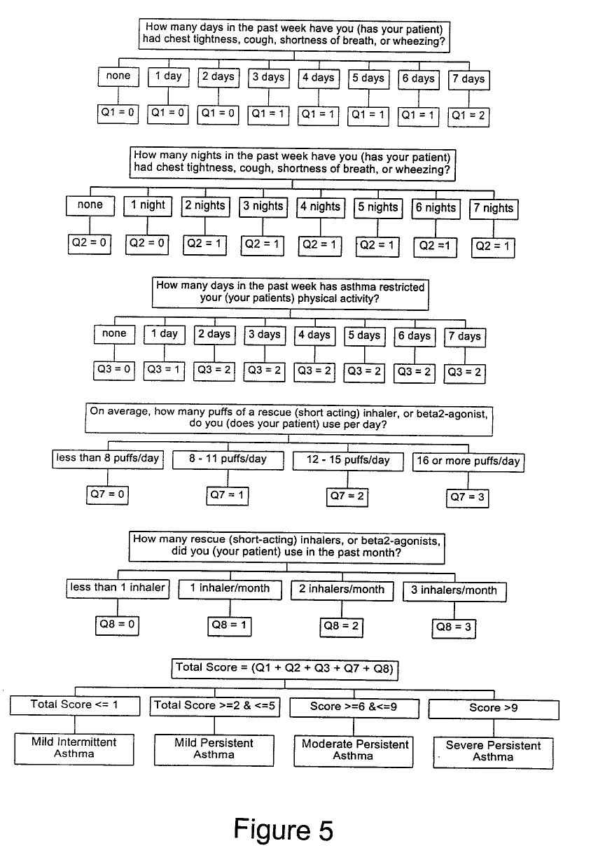

Preferably, the questions will include the following (or similar questions) as illustrated in FIGS. 5-8:

1) How many days in the past week have you [has your patient] had chest tightness, cough, shortness of breath, or wheezing?

2) How many nights in the past week have you [has your patient] had chest tightness, cough, shortness of breath, or wheezing?

3) How many days in the past week has asthma restricted your [your patients] physical activity?

4) How many days of school or work have you [has your patient] missed in the last month due to asthma?

5) Have you [Has your patient] had any asthma attacks since your last doctor's appointment?

6) Have you [Has your patient] had any unscheduled visits to a doctor, including to the emergency room, since your [their] last doctor's appointment?

7) On average, how many puffs of a rescue (short-acting) inhaler, or beta2-agonists, do you [does your patient] use per day?

8) How many rescue (short-acting) inhalers, or beta2-agonists, did you [your patient] use in the past month?

9) Do you [Does your patient] perform peak flow readings at home?

10) Did you [your patient] bring your peak flow diary to your [their] last doctor's appointment?

11) In your opinion, how well controlled is your asthma?

12) How satisfied are you with your asthma care?

The bracketed text preferably replaces the corresponding question text when the user is a healthcare provider, and thus is not included in the questions posed to users who are patients. The question database may include a different number of questions and/or provide more variety of answers. The resulting number of indicator levels preferably then is adjusted to reflect changes in the question database.

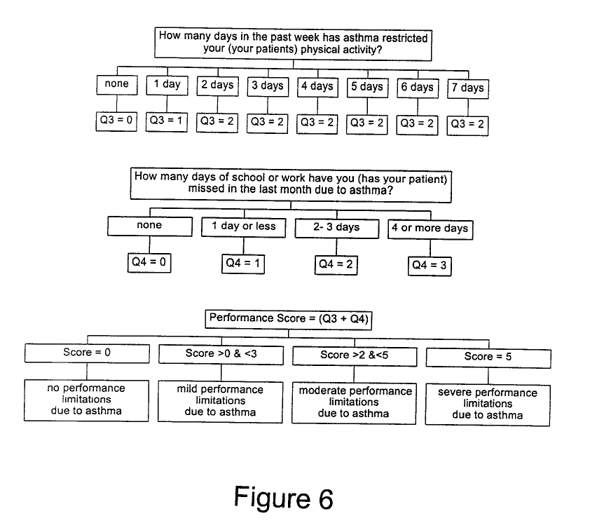

FIGS. 5-8 show the scoring breakdown for each question depending upon the selected answer for each respective question. Questions 1, 2, and 3 preferably are answered by a selection of a discrete number of units, but may also instead be answered by a selection of a range of units because of the scoring breakdown as illustrated, for example, in FIG. 5. Similarly, Questions 4 and 7 alternatively each could be answered by a discrete number of events instead of the illustrated ranges in FIGS. 6 and 5, respectively. Additionally, question 10 is only asked if the answer to question 9 is “yes”. Questions 11 and 12 preferably are for when the user is the patient and are not intended for when the user is the healthcare provider.

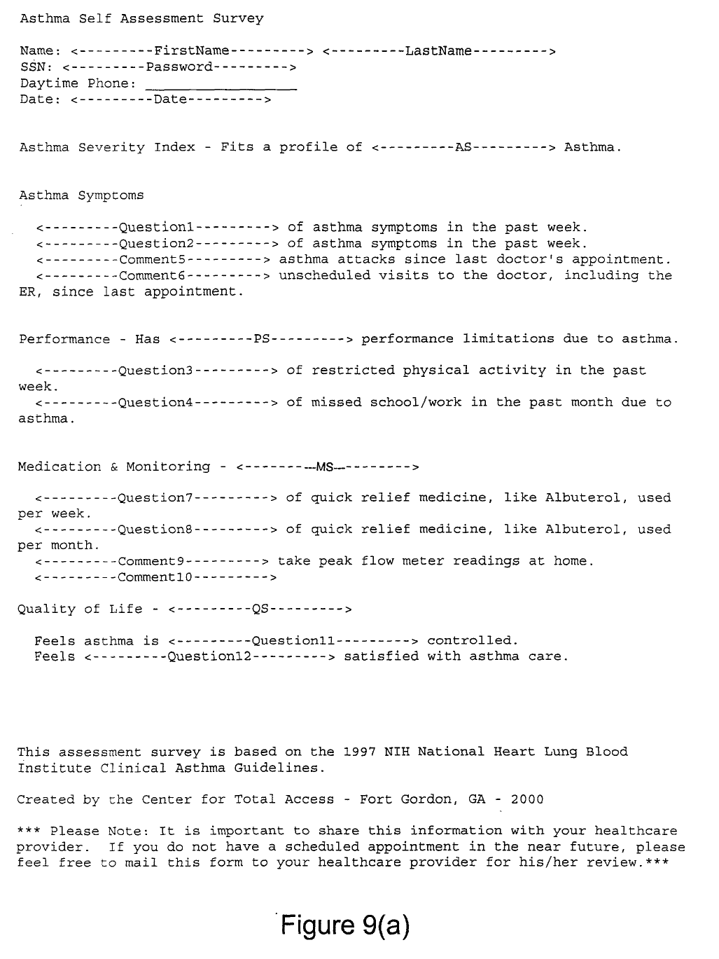

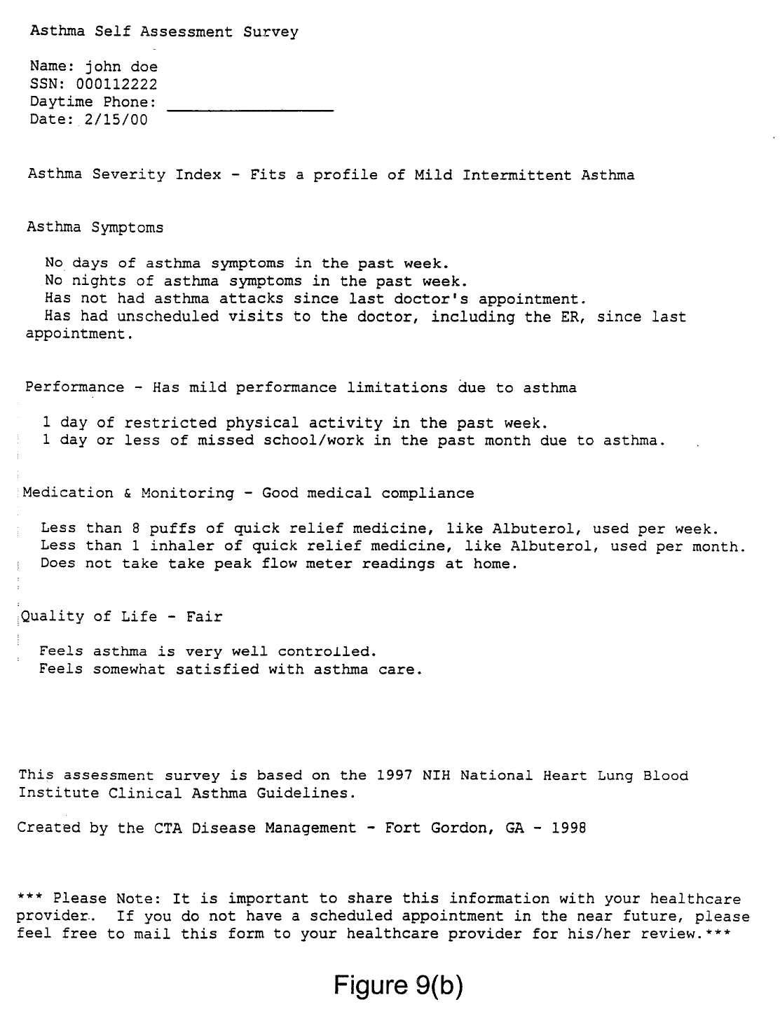

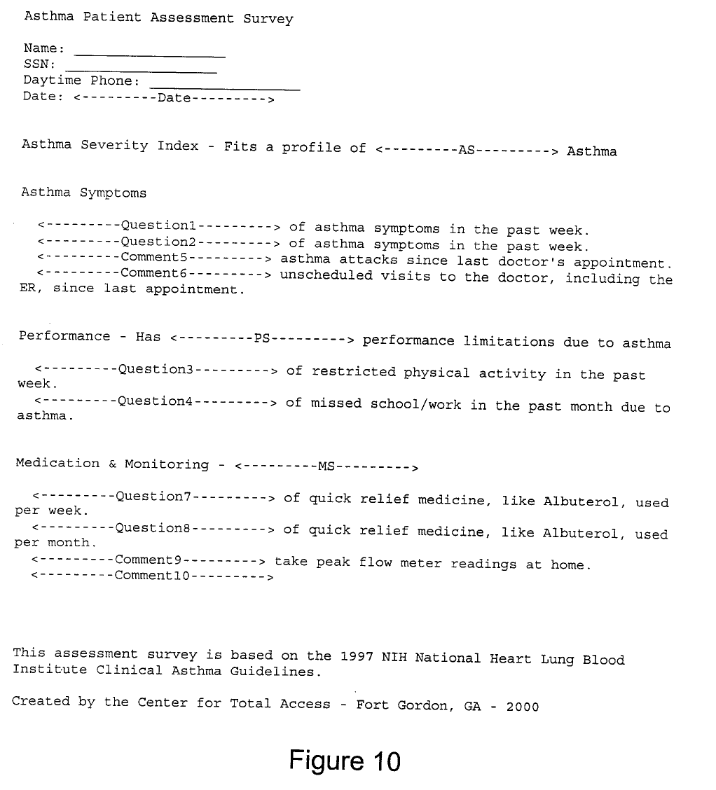

Preferably, questions 1, 2, 3, 7, and 8 are used to determine the severity of the asthma using a weighted value depending upon the answers to each of these questions as shown in FIG. 5. If the total score of these questions is less than or equal to 1, then the patient is suffering from mild intermittent asthma. If the total score is from 2 to 5, then the patient is suffering from mild persistent asthma. If the total score is from 6 to 9, then the patient is suffering from moderate persistent asthma. If the total score is 10 or greater, then the patient has severe persistent asthma. The resulting severity level is then associated with a variable AS, which represents the “asthma severity score,” as illustrated in FIGS. 9(a)-10. The resulting severity level is provided to the user, preferably the user will be provided the opportunity to adjust the asthma severity indicator level one level up or down at the end of the assessment.

Preferably, questions 3 and 4 are used to determine if there are performance limitations for the patient as illustrated in FIG. 6. There preferably are four performance levels: no performance limitations due to asthma (score=0), mild performance limitations due to asthma (score=1 or 2), moderate performance limitations due to asthma (score=3 or 4), and severe performance limitations due to asthma (score=5). The resulting performance indicator level is attached to the variable PS, which represents the “performance score,” as illustrated in FIGS. 9(a)-10.

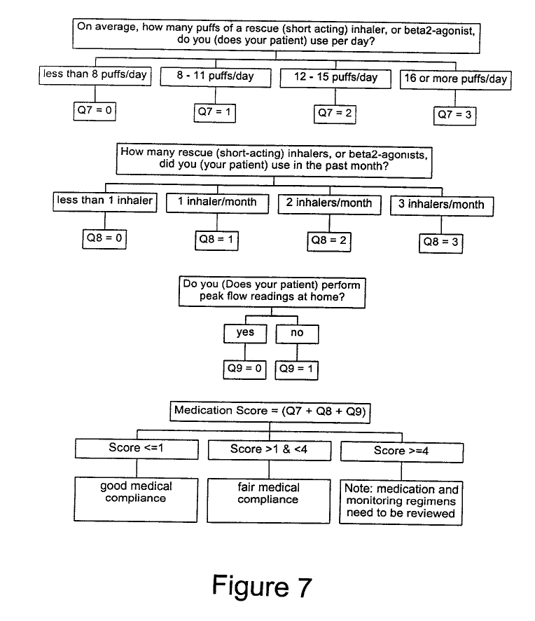

Preferably, questions 7, 8, and 9 are used to determine how well the patient is monitoring his/her asthma and using his/her medication as illustrated in FIG. 7. There preferably are three compliance levels: good medical compliance when the score is 0 or 1, fair medical compliance when the score is 2 or 3, and noncompliance when the score is 4 or greater. When the score is 4 or greater, preferably then the following (or similar) message is provided “[n]ote: medication and monitoring regimens need to be reviewed.” The resulting compliance indicator level is attached to the variable MS, which represents the “medication score,” as illustrated in FIGS. 9(a)-10.

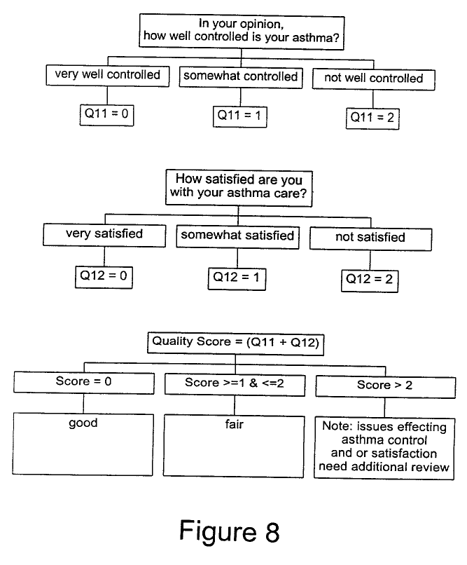

Questions 11 and 12 are used to determine a quality of life for the patient, and preferably are asked only of the patient and not the healthcare provider as illustrated in FIG. 8. The patient preferably has a good quality of life if the score is 0, a fair quality of life if the score is 1 or 2, and a low quality of life if the score is 3 or greater. If there is a low quality of life, then preferably notice is given such as “[n]ote: issues effecting asthma control and or satisfaction need additional review.” This quality of life determination is illustrated in FIG. 8. The resulting indicator level is associated with QS, which represents the “quality of life score,” in FIGS. 9(a)-10.

Preferably at the end of the assessment it is possible to print (and/or display and/or save) a worksheet with all of the information gathered through the assessment. The worksheet may be printed via Microsoft Word or other similar software that allows data to be merged with a template. An exemplary worksheet is shown in FIG. 9(a) for when the user is the patient. Each of the “←XXXXXXX→” where XXXXXXX is replaced with the different pieces of information that were entered as part of the assessment and the initial log in. Where a particular question is listed, it correlates to inserting the selected answer for that question, and not the score value. FIG. 9(b) shows a completed worksheet for “john doe.”

Likewise, when the user is a healthcare provider, they also preferably are given the opportunity to print out a corresponding worksheet such as that illustrated in FIG. 10. The notable differences with the worksheet illustrated in FIG. 9(a) are that the name and social security number are not automatically entered, but this could easily be added into the assessment as the initial questions to enter data about the patient, and the omission of quality of life, which usually is not readily ascertained and/or answered by the healthcare provider without input from the patient.

Preferably based on the result of this self-assessment by the patient, the software presentation becomes tailored to provide the patient with additional information regarding asthma based on the determined severity as illustrated in the branches below Asthma Self Assessment Survey in FIG. 3. An example of this is that the prevention portions are different between mild intermittent asthma and the remaining severity levels in that the mild intermittent asthma only discusses hand washing, while the remaining severity levels also discuss obtaining a flu shot each November. Alternatively or in addition, the information can be tailored for particular classes of patients such as women, the elderly, children 4 years and younger, children older than 4 years old, and/or minorities.

Other sub-menus allow the user to obtain forms and informational materials in printed form upon selecting the option. Preferably such documents are printed via Adobe Acrobat or similar software that will maintain the formatting of the printed documents.

An alternative embodiment is to add a voice over that reads the text shown on the screen during the selected multimedia presentations in each script. Alternatively, the voice over may provide additional information or a summary with respect to the displayed text and/or visual aspects of the presentation.

Another alternative embodiment is to ask the questions such that they cover shorter or longer periods of time such as a month instead of a week. This embodiment preferably will then produce an average for the time period used in the questions above by dividing the answer by the appropriate divisible, which in this case would be four for the questions covering a week if the time was lengthen to a month. Instead of using an average, the scoring system could be scaled to correspond to the changed time periods. A further alternative is to modify the scoring system to be applicable to the time period used in the assessment, and in the previous alternative embodiment the scoring system would be modified for a time period of a month. A yet further alternative is to randomize the time periods to provide additional variety in the question presentation.

Yet another alternative embodiment is to create a database to be associated with these scripts such that as data is entered both in the introduction questions and for the assessment questions a record is developed corresponding preferably either to the name or social security number, which may be replaced by another type of identification number. This alternative embodiment will allow for later analysis of a pool of data relating to asthma and/or allow for tracking of how effective certain therapies are for treating asthma. A further alternative is that identifying information can be selectively not saved to protect privacy of the individuals using the system. Another alternative is for the information to be associated with biometric information for the individual or a smart card (or other type of activation item/mechanism).

Under the previous alternative embodiment, the data may be saved locally and/or at a centralized location. The locally saved information preferably at regular intervals then is forwarded to a centralized location. Possible ways to implement a database include using Microsoft SQL, Oracle, or similar package in conjunction with authoring the underlying software in Macromedia Flash. Preferably, the database will be housed in a SCORM compliant performance/learning management system. This database will assist in tracking the progress of users in terms of treatment and/or education.

The inventors conducted experimental trials with software similar to that described above to determine effectiveness and to fine-tune the software. During these trials, clinical outcome data from patients was collected over a six-month period after experiencing this type of educational program. These patients had statistically significant improvement in their activity levels that were directly related to their control of asthma symptoms. The software preferably is an interactive, multimedia, and fully narrated guide to asthma management for patients. The practitioner software preferably is a comprehensive education program for healthcare providers that can preferably can satisfy the requirements for providing education credits and/or meet continuing education requirements.

This CD-ROM based software preferably is a “Plug & Play,” Local Area Network (LAN) and Internet compatible tool, based on the 1997 NIH and 1999 VA/DoD Clinical Practice Guidelines. The unique properties of this software preferably include animated illustrations that show how bronchospasm and inflammation develop in the airway and how “quick-relief” medicines and “long-term” control medicines work to prevent progression to an asthma attack. An artificially-intelligent, self-assessment tool (Al-SAT) diagnoses a patient's severity of asthma through interactive questions, educates concerning severity-indexed control plans, environmental triggers, and accumulates this information in a performance improvement database (PIDB).

The software also may provide links to current recommended websites such as the National Institute of Health (NIH-National Heart Lung Blood Institute) and Mothers of Asthmatic Children (Allergy and Asthma Network/Mothers of Asthmatics, Inc.). This self-assessment of severity preferably is based on the NIH/National Heart Lung Blood Institutes' Guideline for Asthma Management, which preferably is contained in the DoD/VA Clinical Practice Guidelines that preferably is an example of the type of material available in the practitioner's version.

Those skilled in the art will appreciate that various adaptations and modifications of the above-described devices and steps can be configured without departing from the scope and spirit of the their use in the method. Therefore, it is to be understood that, within the scope of the appended claims, the method may be practiced and arranged other than as specifically described herein.

We claim:

1. A system for scoring an asthma severity for a patient based on information entered by a user regarding the patient comprising:
means for questioning the user regarding the patient,
means for accumulating a score for at least one indicator based on answers entered by the user to the questions,
means for correlating the accumulated score to at least one indicator level, and
means for informing the user of the at least one indicator level from said correlating means.

2. The system according to claim 1, further comprising means for randomizing the order of questions asked by said questioning means, and
wherein said accumulating means accumulates multiple scores for at least two indicators.

3. The system according to claim 2, wherein
the at least two indicators include severity level, compliance level, and performance level, and
said correlating means correlates each score to one of the at least two indicators.

4. The system according to claim 1, further comprising means for providing a summary that includes the answers to the questions and the at least one indicator level.

5. The system according to claim 1, further comprising means for educating the user regarding asthma.

6. A method for assessing asthma patients comprising:
repeating the following for each question of an assessment
asking a question,
receiving an answer to the question, and
incrementing a score for at least one indicator based on the answer to the question;
correlating each of the at least one indicator score to a corresponding at least one indicator level; and
providing the at least one indicator level.

7. The method according to claim 6, wherein providing includes informing the user of the at least one indicator level.

8. The method according to claim 7, further comprising allowing the user to adjust at least one indicator level by at least one level.

9. The method according to claim 7, wherein the at least one indicator includes at least one of a severity level, a compliance level, and a performance level.

10. The method according to claim 7, further comprising educating the user regarding asthma.

11. The method according to claim 10, wherein educating includes showing multimedia presentations to the user.

12. A system comprising:
a device having software to perform the method according to claim 6, and
a display in communication with said device.

13. The method according to claim 6, further comprising storing at least one of the answers and at least one indicator level.

14. A computer data signal embodied in a carrier wave readable by a computing system and encoding a computer program of instructions for executing a computer process performing the method recited in claim 6.

15. A computer-readable medium having computer-executable instructions for the method recited in claim 6.

16. A method for assessing severity of asthma for a patient comprising:
a) transmitting a question to an individual,
b) receiving an answer to the transmitted question from the individual,
c) accumulating a score for at least one indicator based upon the received answer,
d) repeating steps a through c for each question in a series of questions, and
e) transmitting at least one indicator level based on the at least one indicator score to the individual.

17. The method according to 16 further comprising storing the series of answers.

18. The method according to claim 16 further comprising:
transmitting at least one background information question regarding the patient to the individual, and
receiving an answer for each of the at least one background information question from the individual.

19. The method according to claim 18 further comprising personalizing the assessment questions based on the at least one answer received for each of the at least one background information question.

20. The method according to claim 16 further comprising providing a summary of the assessment to the individual.

21. The method according to claim 16 further comprising educating the user about asthma.

22. The method according to claim 21, wherein the educating step includes material tailored to the at least one indicator level of the patient.

23. The method according to claim 16 further comprising providing asthma materials to the user.

24. The method according to claim 23, wherein the provided asthma material provided is based upon the at least one indicator level of the patient.

25. A computer data signal embodied in a carrier wave readable by a computing system and encoding a computer program of instructions for executing a computer process performing the method recited in claim 16.

26. A computer-readable medium having computer-executable instructions for the method recited in claim 16.

27. A system comprising:
a device having software to perform the method according to claim 16, and
a display in communication with said device.

28. The method according to 16 further comprising storing the at least one indicator level.

29. An apparatus for assessing a patient's asthma comprising:
an interface,
a first database in communication with said interface, said first database includes questions relating to asthma,
a calculator in communication with said interface, and
an assessor in communication with said calculator and said interface.

30. The apparatus according to claim 29, wherein said interface includes a graphical component.

31. The apparatus according to claim 29 further comprising a third database in communication with said interface, said third database includes storage for answers to questions from said first database received by said interface.

32. The apparatus according to claim 29 further comprising a fourth database in communication with said interface, said fourth database includes educational materials.

33. The apparatus according to claim 29 further comprising
a processor,
a memory connected to said processor,
a display connected to said processor, and
an input device connected to said processor; and
wherein said interface interacts with said processor such that said processor instructs said display to show said interface on said display and said input device provides an user's input based upon said interface being shown on said display,
said first database resides in said memory, and
said calculator and said assessor reside in said processor.

34. The apparatus according to claim 29 further comprising a second database in communication with said assessor, said second database containing predetermined criteria for use by said assessor in determining at least one indicator level based on a score provided by said calculator.
